(19) United States
(12) Patent Application Publication
(10) Pub. No.: US 2026/0117502 A1
(43) Pub. Date: Apr. 30, 2026

(54) WATER OUTLET HEAD

(71) Applicant: KAIPING HANSHUN SANITARY WARE INDUSTRIAL CO., LTD, Jiangmen (CN)

(72) Inventors: Feiwu HUANG, Jiangmen (CN); Muhuo LAI, Jiangmen (CN); Qingquan LAI, Jiangmen (CN); Yilong LIN, Jiangmen (CN)

(73) Assignee: KAIPING HANSHUN SANITARY WARE INDUSTRIAL CO., LTD, Jiangmen (CN)

(21) Appl. No.: 19/211,202

(22) Filed: May 18, 2025

(30) Foreign Application Priority Data
Oct. 25, 2024 (CN) 2024115056681
Mar. 24, 2025 (CN) 2025205285006

(51) Int. Cl. E03C 1/04; B05B 1/16; B05B 12/00

(52) U.S. Cl. CPC E03C 1/0404; B05B 1/1663; B05B 12/002

(57) ABSTRACT

The present invention provides a water outlet head, including a water outlet main body, a water quantity adjusting member, a switching member, and a combination switch assembly. The water outlet main body is provided with a water inlet channel, a mounting cavity, a first water outlet channel, and a second water outlet channel. The water inlet channel is internally provided with a water passing hole, and the mounting cavity is provided with a water inlet, a first water outlet, and a second water outlet. The combination switch assembly is movably mounted on a circumference of the water outlet main body, connects and controls the water quantity adjusting member through a rotating action, adjusts a size of the water passing hole, and connects and controls the switching member through a pressing action to form a switching action in the mounting cavity.

### CROSS-REFERENCE TO RELATED APPLICATIONS

The application claims priority to Chinese patent application No. 2024115056681, filed on Oct. 25, 2024 and Chinese patent application No. 2025205285006, filed on Mar. 24, 2025, the entire contents of which are incorporated herein by reference.

### TECHNICAL FIELD

The present invention relates to the technical field of kitchens and bathrooms, and in particular, to a water outlet head.

### BACKGROUND

Water outlet heads are mostly applied to faucets of wash basins or kitchen sinks and generally have two water outlet modes: one is common bubble water, and the other is shower water with greater flushing force. Therefore, most of the water outlet heads are equipped with a switching switch. When the water outlet head is in use, the user can pull the water outlet head out with one hand, and the other hand can hold the object to be cleaned, which is convenient for cleaning. At present, a water outlet head is also proposed on the market. On the basis of the above-mentioned switching switch, a flow rate adjusting switch is additionally provided, so that when pulling the water outlet head out with one hand, the user not only can control a water outlet mode of the water outlet head, but also can control the water outlet volume of the water outlet head, meeting more cleaning scenarios and needs. However, the above-mentioned water outlet head has more switches, resulting in a larger overall size of the water outlet head, or under the same size limit, the size of a water passing channel is smaller. Whether the size is too large or the flow rate is small, the operating experience is affected. In addition, the existing water outlet head will not automatically reset to a bubble water state when switching to shower water, which is not convenient for the next use. Therefore, the present invention provides a water outlet head with compact and interrelated switch structures, to solve the above technical problems.

### SUMMARY

To solve the above technical problems, the present invention provides a water outlet head structure with one switch and two control functions.

A water outlet head, including a water outlet main body, a water quantity adjusting member, a switching member, and a combination switch assembly, where

the water outlet main body is provided with a water inlet channel, a telescopic channel, a mounting cavity, a first water outlet channel, and a second water outlet channel. A circumference of the telescopic channel is provided with a water passing hole communicated with the water inlet channel, and the mounting cavity is provided with a water inlet, a first water outlet, and a second water outlet that are correspondingly communicated with the telescopic channel, the first water outlet channel, and the second water outlet channel respectively.

The water quantity adjusting member is telescopically mounted in the telescopic channel and is matched with the water passing hole, and the switching member is movably mounted in the mounting cavity.

The combination switch assembly is movably mounted on a circumference of the water outlet main body, controls the water quantity adjusting member through a rotating action to extend and retract, adjusts a size of the water passing hole, and controls the switching member through a pressing action to form a switching action in the mounting cavity, the water inlet is communicated with the first water outlet or the second water outlet through the switching action of the switching member, and the switching member automatically restores to an initial state in a water shut-off state of the water outlet main body and controls the water inlet, the first water outlet, and the second water outlet to restore to an initial communicated state, so that first water discharging can be performed in a preset water outlet mode during each use, facilitating use.

The water outlet head of the present invention has a water outlet mode switching function and a flow rate adjusting function at the same time, providing great convenience for a consumer during use of water. In addition, the combination switch assembly is disposed, so that two functional modules may be linked simultaneously, that is, one switch can control the water outlet mode and regulate a water outlet quantity. In an aspect, by reducing a disposing quantity of switches, a more compact water outlet head may be formed, which avoids a problem of a large product size or a small water flow channel caused when a plurality of switches are disposed, may not cause a problem that the water outlet head is large in size and is out of proportion with a faucet, and may also not cause a problem of a small water flow rate. In addition, the switching member adopted by the present invention has an automatic reset function after water is shut off, so that the switching member can automatically restore to an initial water outlet mode after each use of water, avoiding trouble for the next use.

Preferably, the combination switch assembly includes a pressing base, a linkage member, and a combination key. The switching member is movably mounted in the mounting cavity, and one end of the switching member extends out of the mounting cavity and forms a pressing end. The pressing base is movably mounted on the circumference of the water outlet main body and is matched with the pressing end of the switching member, and the pressing base drives the pressing end of the switching member through pressing to form the switching action, thereby implementing the water outlet mode switching function. The linkage member is movably mounted on the circumference of the water outlet main body, one end of the linkage member is connected to the water quantity adjusting member, and the other end of the linkage member extends to be close to the pressing base to form a driving end docked with the water quantity adjusting member. The combination key is rotatably mounted at a top of the pressing base and is provided with an eccentric driving head. In an aspect, the combination key can press the pressing base to form a switching function and can be docked with and drive the driving end of the linkage member through rotation and the driving head, to implement a flow adjusting function.

Preferably, the switching member is telescopically mounted along an axis of the water outlet main body and includes a telescopic shaft and a plug. The water inlet is located between the first water outlet and the second water outlet; and when the plug moves with the telescopic shaft to block the second water outlet, the water inlet is communicated with the first water outlet to form a first water outlet mode, or when the plug moves with the telescopic shaft to block the first water outlet, the water inlet is communicated with the second water outlet to form a second water outlet mode.

Preferably, the pressing base squeezes the telescopic shaft through an inclined surface to form the switching action, so that a pressing direction may be changed, and a pressing force of the circumference can also drive the axially disposed switching member.

Preferably, a circumference of the pressing end of the telescopic shaft is provided with a first driving inclined surface and a second driving inclined surface, the pressing base is provided with a first pressing inclined surface and a second pressing inclined surface that face the circumference of the pressing end, the first pressing inclined surface is parallel to the second driving inclined surface, and the second pressing inclined surface is parallel to the first driving inclined surface. The plug is telescopically mounted on the telescopic shaft, and a travel limiting structure is disposed in a telescopic direction, to prevent the plug and the telescopic shaft from separating from each other. A pre-tensioned first spring is disposed between the pressing end of the telescopic shaft and the water outlet main body, and a pre-tensioned second spring is disposed between an end portion of the plug and the water outlet main body.

In the initial state, the second spring pushes and presses the plug onto the second water outlet, the water inlet is communicated with the first water outlet, the first spring pushes the telescopic shaft, a length between the telescopic shaft and the plug is retracted to be in a shortest length state, and the first pressing inclined surface and the second driving inclined surface are staggered in a direction perpendicular to an axis of the telescopic shaft, that is, if the pressing base is pressed at this time, the first pressing inclined surface squeezes the second driving inclined surface, to form a switching action.

In a water passing state, the pressing base is pressed through the combination key, the first pressing inclined surface moves downward, squeezes the second driving inclined surface, and drives the telescopic shaft to push the plug, the plug compresses the second spring and blocks the first water outlet, and the water inlet is communicated with the second water outlet. At this time, the first water outlet mode is switched to the second water outlet mode. Then, the pressing base is reset by releasing the combination key, water pressure in the mounting cavity is greater than elasticity of the second spring, a state that the plug blocks the first water outlet is maintained, and the water pressure in the mounting cavity pushes the telescopic shaft to reset and compress the first spring. At this time, the length between the telescopic shaft and the plug is extended to be in a longest length state, and the second pressing inclined surface and the first driving inclined surface are staggered in the direction perpendicular to the axis of the telescopic shaft. When the pressing base is pressed through the combination key again, the second pressing inclined surface moves downward, squeezes the first driving inclined surface, and drives the telescopic shaft to pull out the plug, the plug opens the first water outlet and blocks the second water outlet, and a state of blocking the second water outlet is maintained through an elastic force of the second spring and a water force. At this time, the second water outlet mode is switched to the first water outlet mode. After water stops in the water outlet main body, the switching member restores to the initial state.

Preferably, one end, facing the telescopic shaft, of the plug is provided with a telescopic groove, a groove opening of the telescopic groove is a contraction opening, one end, facing the plug, of the telescopic shaft is provided with a piston head, an end portion of the piston head is provided with a telescopic rod inserted into the telescopic groove, an end portion of the telescopic rod is provided with a limiting head with a diameter greater than that of the contraction opening, and the travel limiting structure is formed between the telescopic groove and the telescopic rod. The telescopic shaft performs a reciprocating movement in the mounting cavity through the piston head, and a V-shaped opening sealing ring with an opening facing the plug is sleeved on an outer ring of the piston head.

Preferably, a compressed third spring is disposed between the pressing base and the water outlet main body, and the third spring pushes the pressing base to be away from the pressing end of the switching member, to implement that the pressing base may automatically reset after being released. The water outlet main body is provided with limiting plates on two sides of the pressing base, and the two limiting plates are provided with undercuts limiting the pressing base from separating from a mounting position. Tops of the two limiting plates are provided with parallel and opposite strip-shaped openings, the strip-shaped openings are parallel to a moving direction of the pressing base, and contraction openings are formed at the openings. A top of the pressing base is provided with arc-shaped grooves communicated with the two strip-shaped openings. During mounting, a rotating shaft of the combination key is clamped into the two strip-shaped openings and abuts against the arc-shaped grooves, the combination key rotates on the arc-shaped grooves and in the strip-shaped openings through the rotating shaft, or/and the combination key performs a reciprocating movement in the two strip-shaped openings through the rotating shaft and presses the pressing base.

Preferably, the linkage member is telescopically mounted along an axis of the water outlet main body, a circumference of the driving end is provided with a docked opening parallel to a moving direction of the pressing base, a depth of the docked opening is greater than a diameter of the driving head, the driving head of the combination key is clamped into the docked opening, and when the driving head rotates around the rotating shaft of the combination key, the driving head forms, in the docked opening, an action of pushing the docked opening and an action of a reciprocating movement along the docked opening, thereby driving the linkage member to perform a reciprocating movement along the axis of the water outlet main body. The water quantity adjusting member is columnar, is telescopically mounted in the telescopic channel, and is driven by the linkage member. The water quantity adjusting member blocks the telescopic channel, a middle portion of the water quantity adjusting member is provided with a water passing groove, a circumference of the water quantity adjusting member is provided with an adjusting hole communicated with the water passing groove, and a groove opening of the water passing groove is communicated with the water inlet of the mounting cavity through the telescopic channel. The water passing hole is formed on a movement track of the adjusting hole, and the water quantity adjusting member adjusts a water passing quantity of the water inlet channel through a staggered degree between the adjusting hole and the water passing hole.

A structure is simple and is easy to form and assemble.

Preferably, the combination key is provided with a pressing roller coaxial with a rotating shaft of the combination key; when the pressing roller rotates toward one direction and reaches a limiting position, the adjusting hole is completely communicated with the water passing hole, and a water flow rate is maximum; or when the pressing roller rotates toward the other direction and reaches a limiting position, the adjusting hole and the water passing hole are completely staggered, and a water flow rate is minimum. Therefore, when the pressing roller rolls toward one direction, the water outlet quantity may be reduced, and when the pressing roller rolls toward the other direction, the water outlet quantity may be increased, which facilitates use and may avoid a condition that an error occurs on flow rate adjustment.

Preferably, the water outlet head further includes a housing, one end of the housing is a mounting opening, and the other end of the housing is a mounting contraction opening; the water outlet main body is inserted from the mounting opening of the housing, and a water inlet end of the water outlet main body is circumferentially provided with a thread, extends out of the mounting contraction opening of the housing, and is screwed and fastened through a nut; and the housing is provided with an avoidance hole corresponding to the combination switch assembly, and the pressing roller is docked with the combination key through the avoidance hole and is exposed from the avoidance hole, thereby further limiting the water outlet main body in the housing.

Preferably, the pressing roller is assembled with the combination key through a snap fit and a screw or in a bonded manner.

Preferably, water outlet ends of the first water outlet channel and the second water outlet channel form a bubble water outlet nozzle and a shower water outlet nozzle respectively.

Preferably, the water quantity adjusting member and the switching member are disposed side by side in a radial direction of the water outlet main body.

Preferably, one side of the water outlet main body is provided with a first through hole communicated with the mounting cavity, the other side of the water outlet main body is provided with a second through hole communicated with the telescopic channel, the first through hole allows the pressing end of the switching member to extend out of the mounting cavity, and the second through hole allows the linkage member to be connected to the water quantity adjusting member.

Preferably, the linkage member includes a bottom wall and side walls connected to two ends of the bottom wall of the linkage member respectively, the bottom wall and the two side walls of the linkage member form a U-shaped structure, the U-shaped structure is sleeved on a periphery of the water outlet main body, an inner surface of the bottom wall or the side wall of the linkage member is provided with a clamping rib, and an outer surface of the water quantity adjusting member is provided with a clamping groove matched with the clamping rib.

Preferably, the linkage member is telescopically mounted along an axis of the water outlet main body, the side wall of the linkage member is provided with a docked opening parallel to a moving direction of the pressing base, and the driving head of the combination key is clamped into the docked opening and drives the linkage member to perform a reciprocating movement along the axis of the water outlet main body.

Preferably, a top end of the side wall of the linkage member is provided with a barb, the water outlet main body is provided with a stepped surface matched with the barb, an outer surface of the water outlet main body is axially provided with a groove or a protruding rib, and the inner surface of the side wall or the bottom wall of the linkage member is provided with a protruding rib or a groove matched with the groove or the protruding rib.

Preferably, the water outlet main body includes, in a water flow direction, a water inlet section, a middle section, and a water outlet section that are connected sequentially, the water inlet channel includes a first water inlet channel and a second water inlet channel that are communicated sequentially, the first water inlet channel is located in the water inlet section, the second water inlet channel, the telescopic channel, and the mounting cavity are integrally formed in the middle section, and the telescopic channel is located on one side of the mounting cavity and the second water inlet channel.

Preferably, the telescopic channel and the second water inlet channel respectively and axially extend to an end portion of one end, connected to the water inlet section, of the middle section, forming a first end opening of the telescopic channel and an inlet of the second water inlet channel respectively, one end, facing the middle section, of the water inlet section is provided with an outlet of the first water inlet channel and a blocking portion respectively, the outlet of the first water inlet channel is in sealing connection with the inlet of the second water inlet channel when the water inlet section is connected to the middle section, and the blocking portion blocks the first end opening of the telescopic channel; and a position, corresponding to the water passing hole, on a side wall of the second water inlet channel is provided with a process hole forming the water passing hole, and the process hole is sealed through a sealing stopper.

Preferably, the water outlet head further includes a housing, one end of the housing is a mounting opening, and the other end of the housing is a mounting contraction opening; the water outlet main body is inserted from the mounting opening of the housing, and the water inlet section of the water outlet main body is circumferentially provided with a thread, extends out of the mounting contraction opening of the housing, and is screwed and fastened through a nut; and the housing is provided with an avoidance hole corresponding to the combination switch assembly.

It can be known from the above description of the present invention that the present invention has the following beneficial effects:
1. The water outlet head of the present invention has a water outlet mode switching function and a flow rate adjusting function at the same time, providing great convenience for a consumer during use of water. In addition, the combination switch assembly is disposed, so that two functional modules may be linked simultaneously, that is, one switch can control the water outlet mode and regulate a water outlet quantity. In an aspect, by reducing a disposing quantity of switches, a more compact water outlet head may be formed, which avoids a problem of a large product size or a small water flow channel caused when a plurality of switches are disposed, may not cause a problem that the water outlet head is large in size and is out of proportion with a faucet, and may also not cause a problem of a small water flow rate.
2. The switching member adopted by the present invention has an automatic reset function after water is shut off, so that the switching member can automatically restore to an initial water outlet mode after each use of water, avoiding trouble for the next use.
3. The combination key adopted by the present invention can rotate and move in a direction perpendicular to the rotating shaft, so that the combination key may enable the driving head that is eccentrically disposed to drive the linkage member and the water quantity adjusting member to move and may also form the pressing action on the pressing base.
4. The switching member adopts a telescopic structure, so that the elastic force of the spring and the water force of water to form and maintain different water outlet states, and the structure is simple and ingenious.
5. Two groups of inclined surfaces are disposed between the pressing base and the telescopic shaft, so that an action of pushing or pulling out the telescopic shaft by the pressing base may be implemented through the two groups of inclined surfaces.
6. According to the water outlet head of the present invention, the water quantity adjusting member and the switching member are disposed side by side in a radial direction of the water outlet main body. In this design, on the basis that the water outlet head has a function that one switch can control the water outlet mode and can regulate the water outlet quantity, the length of the water outlet head may be reduced to a great extent, so that the overall structure of the water outlet head is shorter and more compact and is more in line with a requirement for miniaturized design of the water outlet head of the consumer.

### BRIEF DESCRIPTION OF THE DRAWINGS

The accompanying drawings described herein are intended for further understanding of the present invention and constitute a part of the present invention. Schematic embodiments of the present invention and descriptions thereof are intended to explain the present invention, and do not constitute any inappropriate limitation on the present invention.

In the accompanying drawings:

FIG. 1 is an axial side view I of a water outlet head according to a first embodiment of the present invention;

FIG. 2 is an axial side view II of a water outlet head according to a first embodiment of the present invention; (a housing is hidden)

FIG. 3 is an exploded view I of a water outlet head according to a first embodiment of the present invention;

FIG. 4 is an exploded view II of a water outlet head according to a first embodiment of the present invention; (a housing is hidden)

FIG. 5 is a three-dimensional sectional view of a water outlet head according to a first embodiment of the present invention;

FIG. 6 is a partial enlarged view of a water outlet head according to a first embodiment of the present invention; (related to a position A in FIG. 5)

FIG. 7 is a sectional view I of a water outlet head according to a first embodiment of the present invention; (an initial state, a water shut-off state, and a minimum water outlet quantity state)

FIG. 8 is a sectional view II of a water outlet head according to a first embodiment of the present invention; (a first switching action, switching to a water passing state of a second water outlet channel)

FIG. 9 is a sectional view III of a water outlet head according to a first embodiment of the present invention; (a first switching action releasing state and a maximum water outlet quantity state)

FIG. 10 is a sectional view IV of a water outlet head according to a first embodiment of the present invention; (a second switching action, switching to a water passing state of a first water outlet channel)

FIG. 11 is a sectional view V of a water outlet head according to a first embodiment of the present invention; (a second switching action releasing state)

FIG. 12 is an axial side view I of a water outlet head according to a second embodiment of the present invention;

FIG. 13 is an axial side view II of a water outlet head according to a second embodiment of the present invention; (a housing is hidden)

FIG. 14 is an exploded view of a water outlet head according to a second embodiment of the present invention;

FIG. 15 is a sectional view I of a water outlet head according to a second embodiment of the present invention;

FIG. 16 is a sectional view II of a water outlet head according to a second embodiment of the present invention; (a housing is hidden)

FIG. 17 is a front view of a water outlet head according to a second embodiment of the present invention; (a housing is hidden)

FIG. 18 is an axial side view I of a middle section of a water outlet main body according to a second embodiment of the present invention;

FIG. 19 is an axial side view II of a middle section of a water outlet main body according to a second embodiment of the present invention;

FIG. 20 is a three-dimensional sectional view of a middle section of a water outlet main body according to a second embodiment of the present invention;

FIG. 21 is an axial side view of a linkage member according to a second embodiment of the present invention;

FIG. 22 is an axial side view of a water quantity adjusting member according to a second embodiment of the present invention;

FIG. 23 is a sectional view I of a water flow state of a water outlet head according to a second embodiment of the present invention; (a shower water outlet nozzle discharges water and a maximum water outlet quantity state at this time)

FIG. 24 is a sectional view II of a water flow state of a water outlet head according to a second embodiment of the present invention; (a bubble water outlet nozzle discharges water and a maximum water outlet quantity state at this time)

FIG. 25 is a sectional view III of a water flow state of a water outlet head according to a second embodiment of the present invention; (a small water outlet quantity state at this time) and

FIG. 26 is a sectional view IV of a water flow state of a water outlet head according to a second embodiment of the present invention. (a maximum water outlet quantity state at this time)

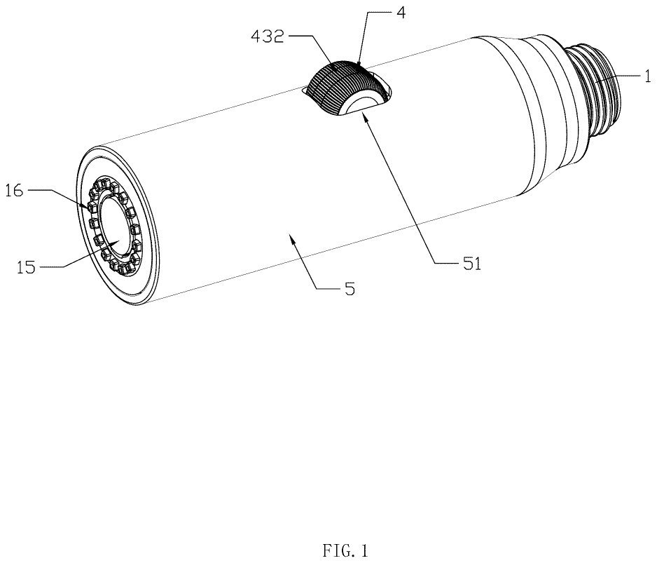

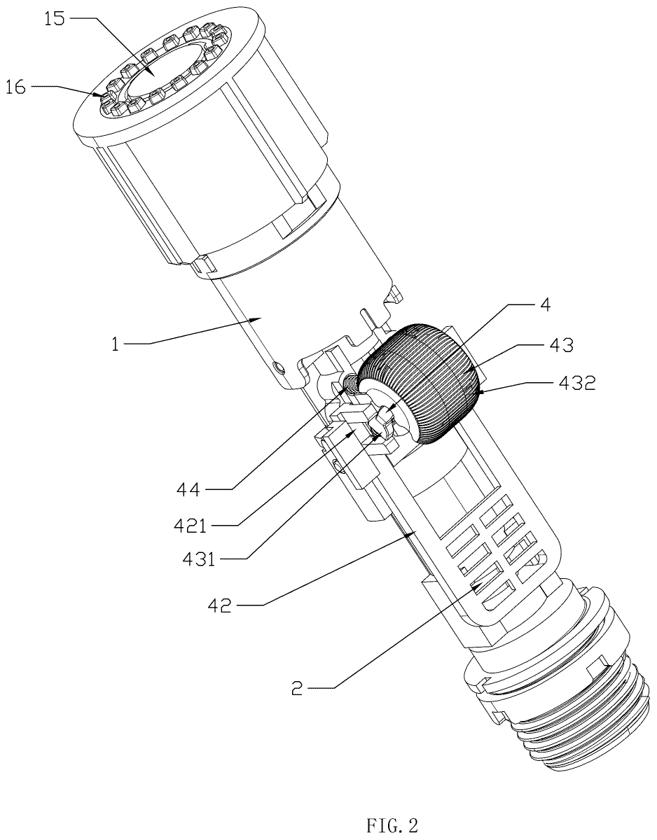

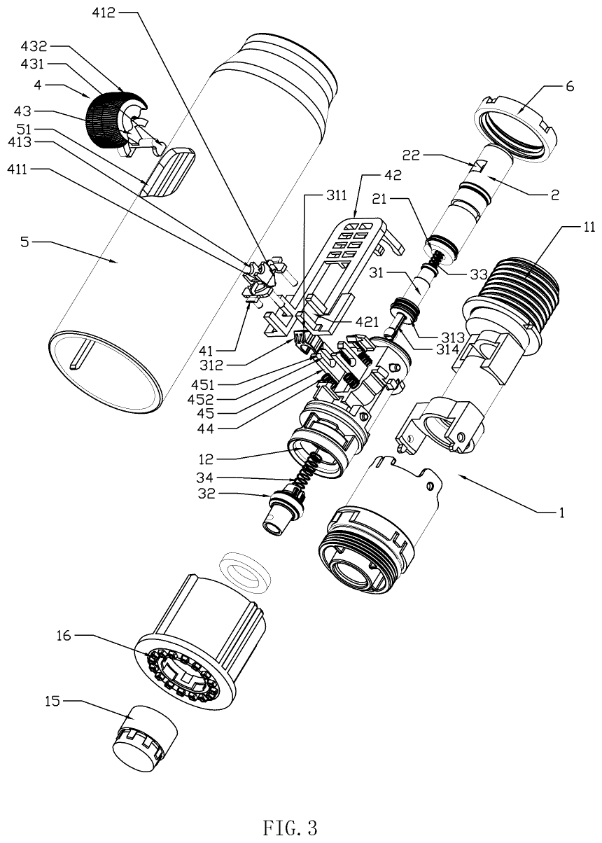

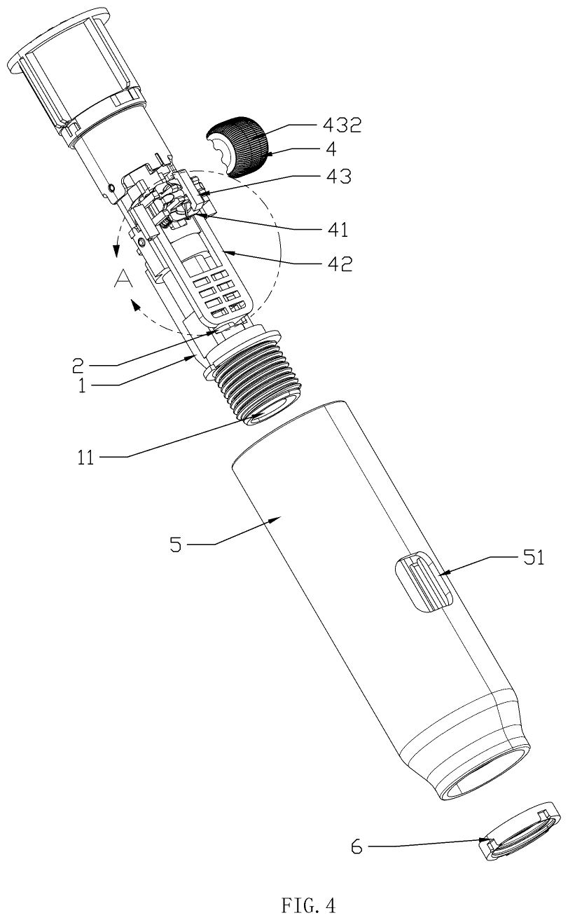

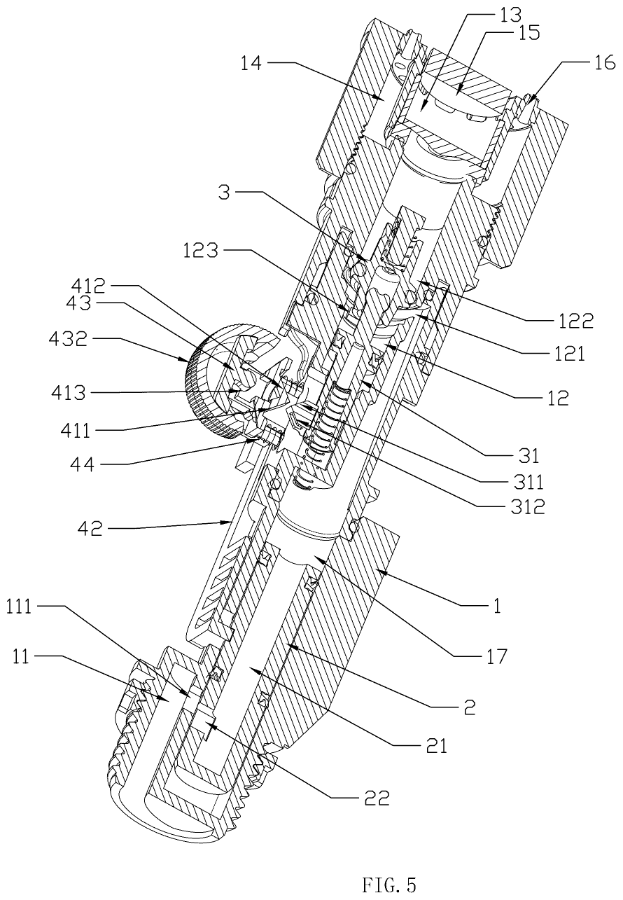

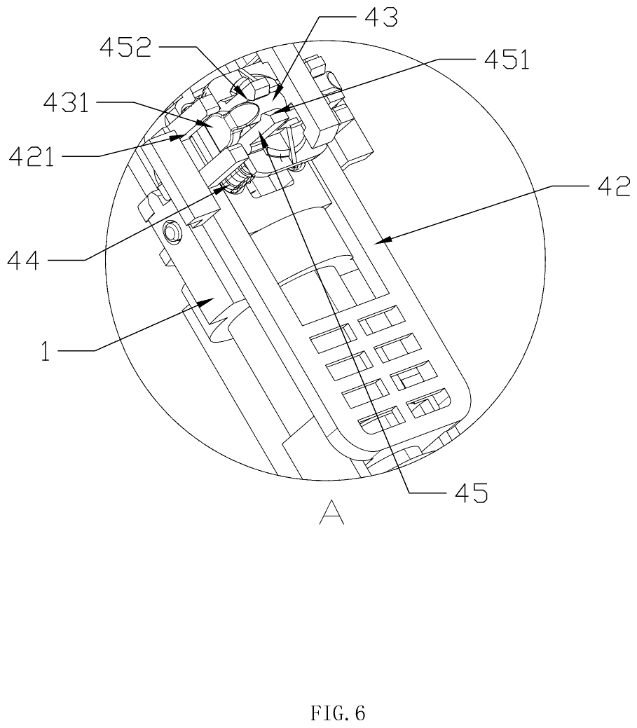

Reference numerals in FIG. 1 to FIG. 11 of a first embodiment respectively are as follows:
water outlet main body 1; water inlet channel 11; water passing hole 111; mounting cavity 12; water inlet 121; first water outlet 122; second water outlet 123; first water outlet channel 13; second water outlet channel 14; bubble water outlet nozzle 15; shower water outlet nozzle 16; telescopic channel 17; water quantity adjusting member 2; water passing groove 21; adjusting hole 22; switching member 3; telescopic shaft 31; first driving inclined surface 311; second driving inclined surface 312; piston head 313; telescopic rod 314; plug 32; telescopic groove 321; first spring 33; second spring 34; combination switch assembly 4; pressing base 41; first pressing inclined surface 411; second pressing inclined surface 412; arc-shaped groove 413; linkage member 42; docked opening 421; combination key 43; driving head 431; pressing roller 432; third spring 44; limiting plate 45; undercut 451; strip-shaped opening 452, housing 5; avoidance hole 51; nut 6;

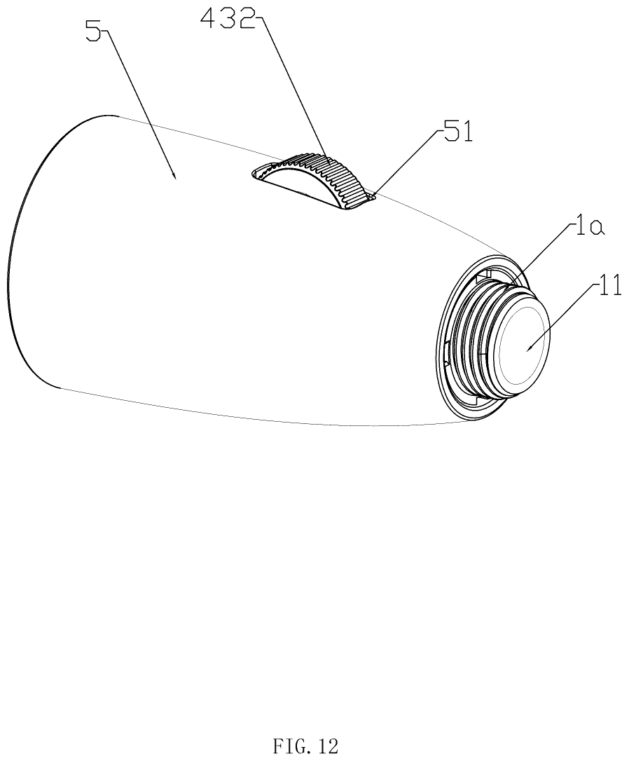

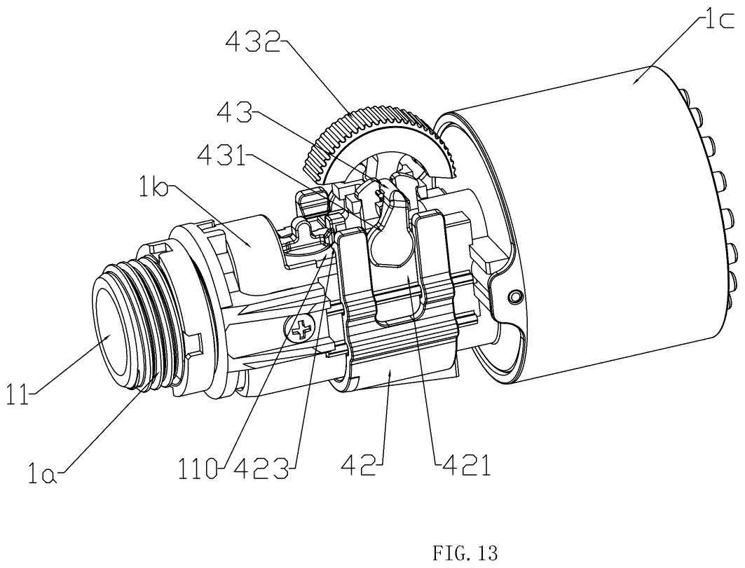

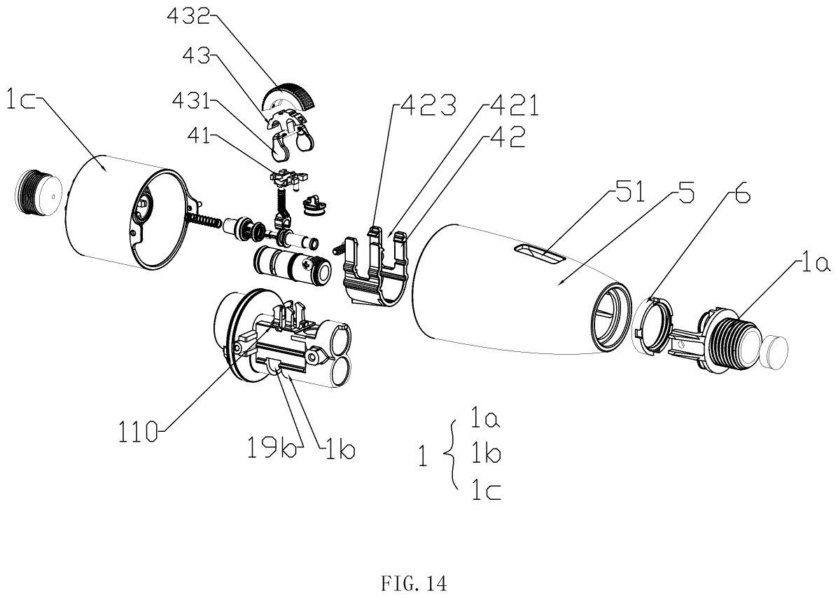

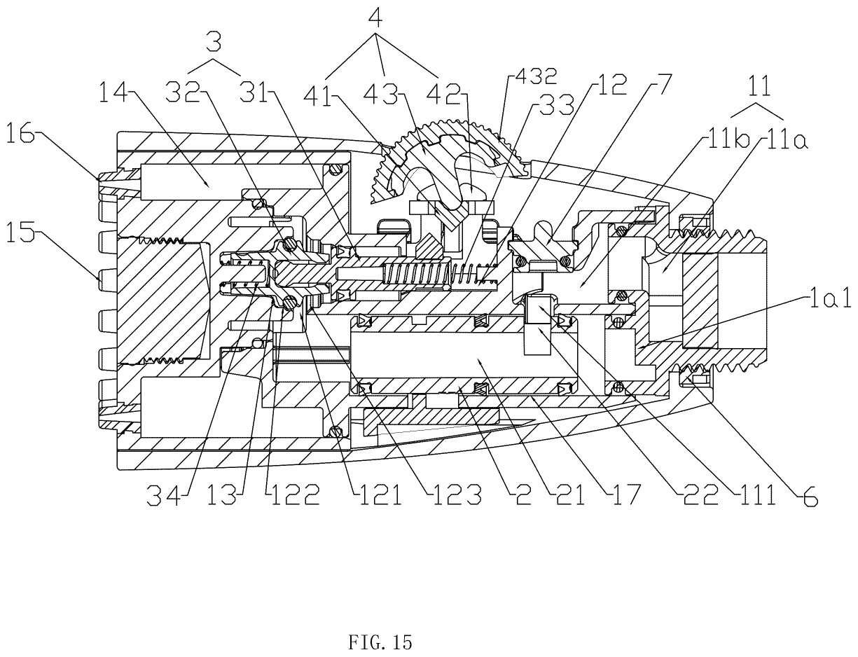

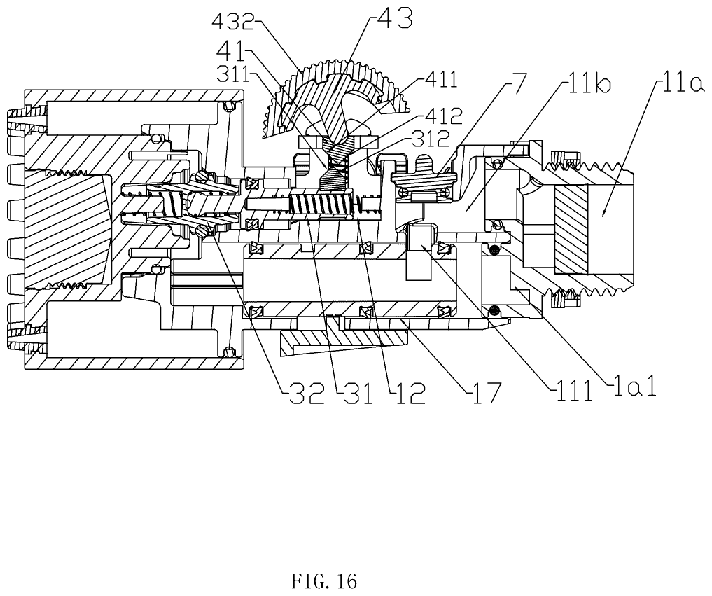

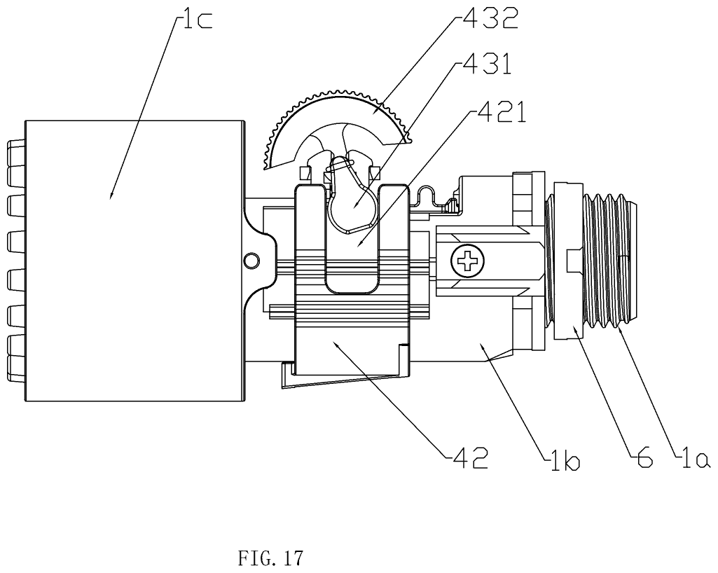

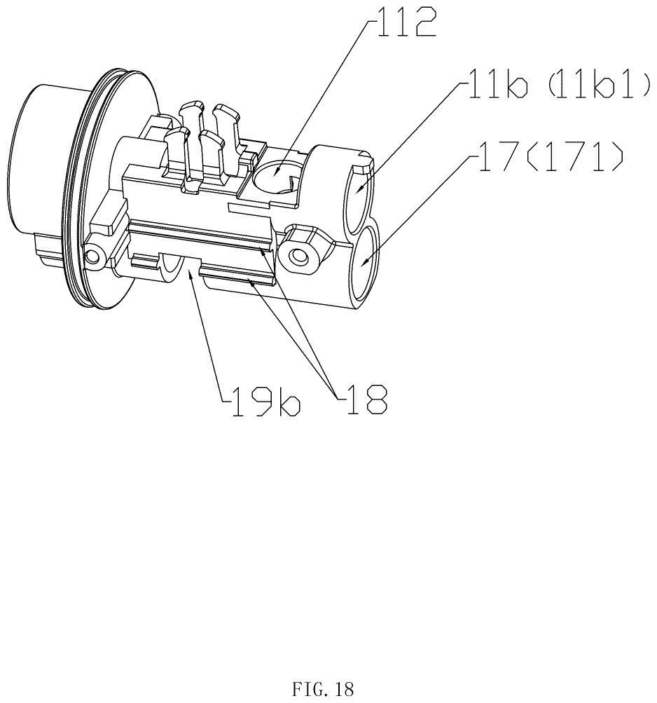

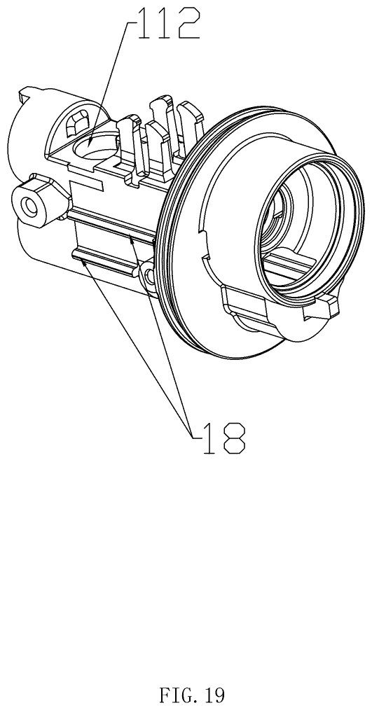

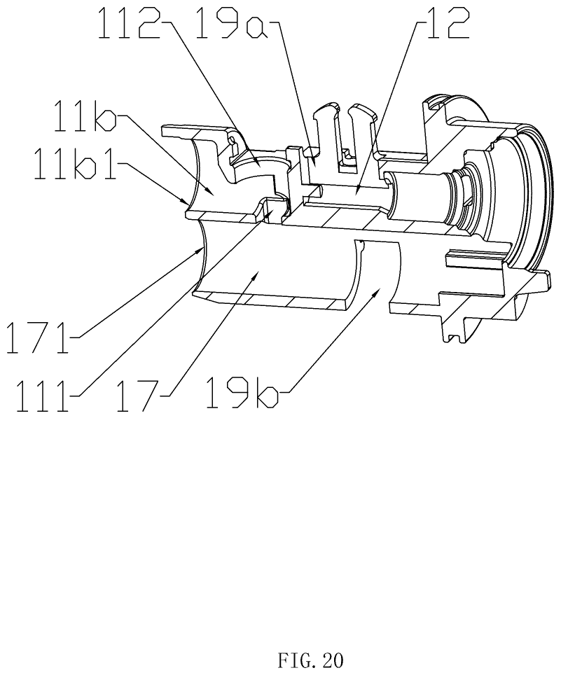

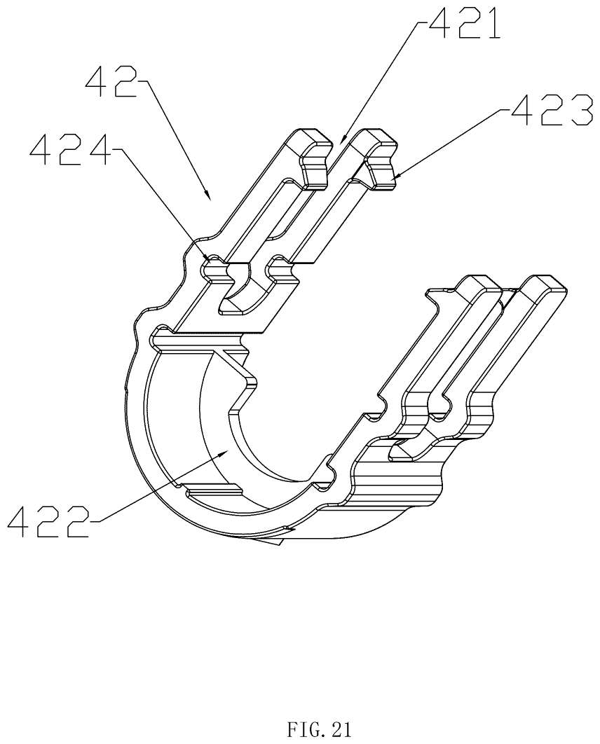

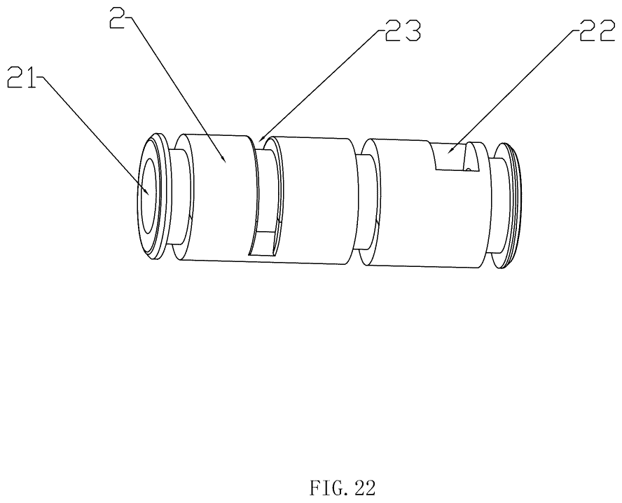

Reference numerals in FIG. 12 to FIG. 26 of a second embodiment respectively are as follows:
water outlet main body 1; water inlet section 1a; blocking portion 1a1; middle section 1b; water outlet section 1c; water inlet channel 11; first water inlet channel 11a; second water inlet channel 11b; inlet 11b1 of the second water inlet channel; water passing hole 111; process hole 112; mounting cavity 12; water inlet 121; first water outlet 122; second water outlet 123; first water outlet channel 13; second water outlet channel 14; bubble water outlet nozzle 15; shower water outlet nozzle 16; telescopic channel 17; a first end opening 171 of the telescopic channel; protruding rib 18; first through hole 19a; second through hole 19b; stepped surface 110; water quantity adjusting member 2; water passing groove 21; adjusting hole 22; clamping groove 23; switching member 3; telescopic shaft 31; first driving inclined surface 311; second driving inclined surface 312; plug 32; first spring 33; second spring 34; combination switch assembly 4; pressing base 41; first pressing inclined surface 411; second pressing inclined surface 412; linkage member 42; docked opening 421; clamping rib 422; barb 423; groove 424; combination key 43; driving head 431; pressing roller 432; housing 5; avoidance hole 51; nut 6; sealing stopper 7.

### DETAILED DESCRIPTION OF THE EMBODIMENTS

To make the technical problems to be solved, technical solutions, and beneficial effects in the present invention clearer and more comprehensible, the following further describes the present invention in detail with reference to the accompanying drawings and embodiments. It should be understood that the specific embodiments described herein are merely used to explain the present invention but not to limit the present invention.

### First Embodiment

Referring to FIG. 1 to FIG. 11, a water outlet head of a first embodiment provided by the present invention includes a water outlet main body 1, a water quantity adjusting member 2, a switching member 3, and a combination switch assembly 4.

The water outlet main body 1 is provided with a water inlet channel 11, a telescopic channel 17, a mounting cavity 12, a first water outlet channel 13, and a second water outlet channel 14. A circumference of the telescopic channel 17 is provided with a water passing hole 111 communicated with the water inlet channel 11, and the mounting cavity 12 is provided with a water inlet 121, a first water outlet 122, and a second water outlet 123 that correspond to the telescopic channel 17, the first water outlet channel 13, and the second water outlet channel 14 respectively. Preferably, water outlet ends of the first water outlet channel 13 and the second water outlet channel 14 form a bubble water outlet nozzle 15 and a shower water outlet nozzle 16 respectively.

The water quantity adjusting member 2 is telescopically mounted in the telescopic channel 17 and is close to the water passing hole 111, and the switching member 3 is movably mounted in the mounting cavity 12. The combination switch assembly 4 is movably mounted on a circumference of the water outlet main body 1, connects and controls the water quantity adjusting member 2 through a rotating action, adjusts a size of the water passing hole, and connects and controls the switching member 3 through a pressing action to form a switching action in the mounting cavity 12. The water inlet 121 is communicated with the first water outlet 122 or the second water outlet 123 through the switching action of the switching member 3, and the switching member 3 automatically restores to an initial state in a water shut-off state of the water outlet main body 1 and controls the water inlet 121, the first water outlet 122, and the second water outlet 123 to restore to an initial communicated state, so that first water discharging can be performed in a preset water outlet mode during each use, facilitating use.

For the combination switch assembly 4, in this embodiment, the combination switch assembly 4 includes a pressing base 41, a linkage member 42, and a combination key 43. The switching member 3 is movably mounted in the mounting cavity 12, and one end of the switching member extends out of the mounting cavity 12 and forms a pressing end. The pressing base 41 is movably mounted on the circumference of the water outlet main body 1 and is close to the pressing end of the switching member 3, and the pressing base 41 drives the pressing end of the switching member 3 through pressing to form the switching action, thereby implementing a water outlet mode switching function. The linkage member 42 is movably mounted on the circumference of the water outlet main body 1, one end of the linkage member is connected to the water quantity adjusting member 2, and the other end of the linkage member extends to be close to the pressing base 41 to form a driving end docked with the water quantity adjusting member 2. The combination key 43 is rotatably mounted at a top of the pressing base 41 and is provided with an eccentric driving head 431. In an aspect, the combination key 43 can press the pressing base 41 to form a switching function and can be docked with and drive the driving end of the linkage member 42 through rotation and the driving head 431, to implement a flow adjusting function.

Furthermore, the switching member 3 is telescopically mounted along an axis of the water outlet main body 1 and includes a telescopic shaft 31 and a plug 32. The water inlet 121 is located between the first water outlet 122 and the second water outlet 123. When the plug 32 moves with the telescopic shaft 31 to block the second water outlet 123, the water inlet 121 is communicated with the first water outlet 122 to form a first water outlet mode, or when the plug 32 moves with the telescopic shaft 31 to block the first water outlet 122, the water inlet 121 is communicated with the second water outlet 123 to form a second water outlet mode. In addition, preferably, the pressing base 41 squeezes the telescopic shaft 31 through an inclined surface to form the switching action, so that a pressing direction may be changed, and a pressing force of the circumference can also drive the axially disposed switching member 3.

For the above inclined surface squeezing structure, in the specific embodiment, a circumference of the pressing end of the telescopic shaft 31 is provided with a first driving inclined surface 311 and a second driving inclined surface 312, and the pressing base 41 is provided with a first pressing inclined surface 411 and a second pressing inclined surface 412 that face the circumference of the pressing end. The first pressing inclined surface 411 is parallel to the second driving inclined surface 312, and the second pressing inclined surface 412 is parallel to the first driving inclined surface 311. The plug 32 is telescopically mounted on the telescopic shaft 31, and a travel limiting structure is disposed in a telescopic direction, to prevent the plug 32 and the telescopic shaft 31 from separating from each other. A pre-tensioned first spring 33 is disposed between the pressing end of the telescopic shaft 31 and the water outlet main body 1, and a pre-tensioned second spring 34 is disposed between an end portion of the plug 32 and the water outlet main body 1.

A use principle of the switching function of the water outlet head provided in this embodiment is as follows:

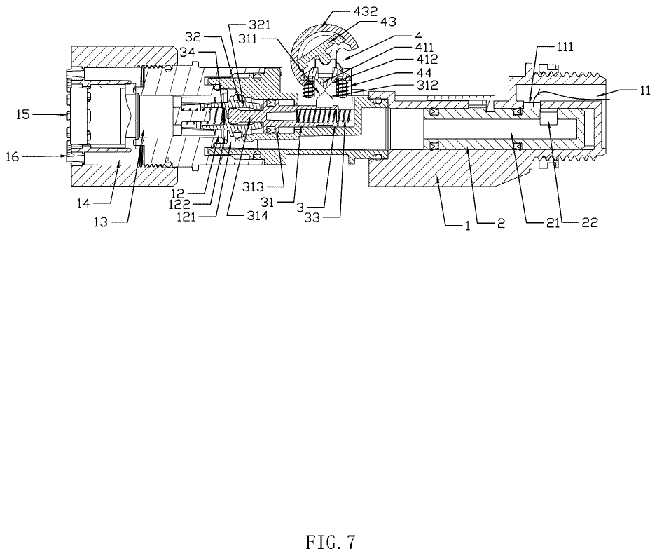

In the initial state, as shown in FIG. 7, the second spring 34 pushes and presses the plug 32 onto the second water outlet 123, and the water inlet 121 is communicated with the first water outlet 122. The first spring 33 pushes the telescopic shaft 31, a length between the telescopic shaft 31 and the plug 32 is retracted to be in a shortest length state, and the first pressing inclined surface 411 and the second driving inclined surface 312 are staggered in a direction perpendicular to an axis of the telescopic shaft 31, that is, if the pressing base 41 is pressed at this time, the first pressing inclined surface 411 squeezes the second driving inclined surface 312, to form a switching action.

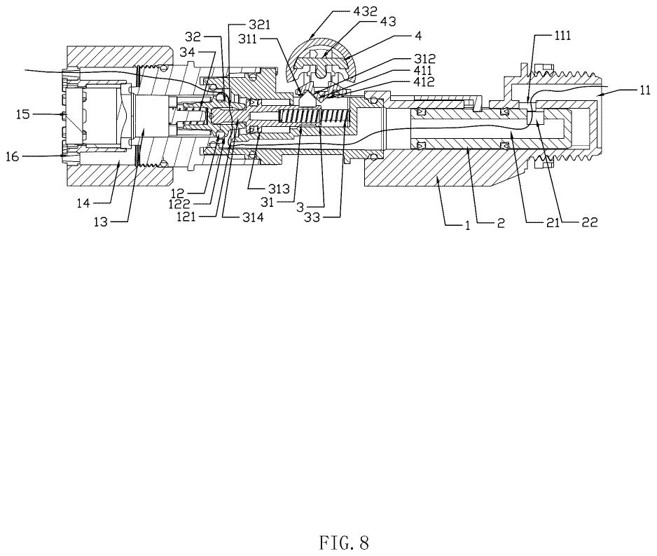

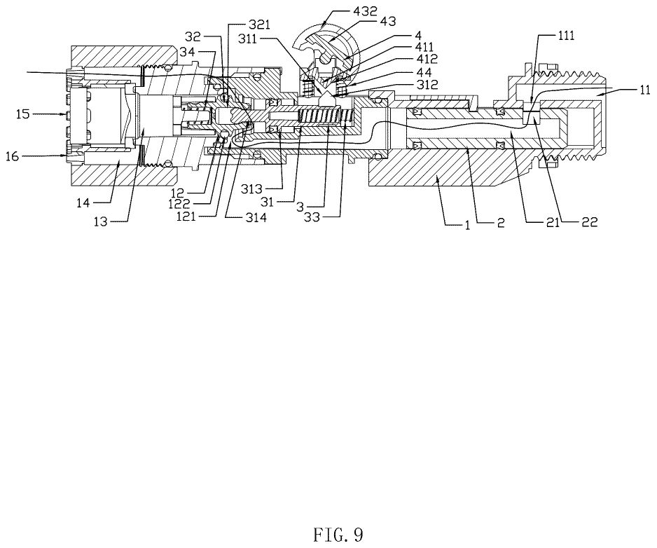

In a water passing state, the pressing base 41 is pressed through the combination key 43. Referring to FIG. 8, the first pressing inclined surface 411 moves downward, squeezes the second driving inclined surface 312, and drives the telescopic shaft 31 to push the plug 32. The plug 32 compresses the second spring 34 and blocks the first water outlet 122, and the water inlet 121 is communicated with the second water outlet 123. At this time, the first water outlet mode is switched to the second water outlet mode. Then, referring to FIG. 9, the pressing base 41 is reset by releasing the combination key 43, water pressure in the mounting cavity 12 is greater than elasticity of the second spring 34, a state that the plug 32 blocks the first water outlet 122 is maintained, and the water pressure in the mounting cavity 12 pushes the telescopic shaft 31 to reset and compress the first spring 33. At this time, the length between the telescopic shaft 31 and the plug 32 is extended to be in a longest length state, and the second pressing inclined surface 412 and the first driving inclined surface 311 are staggered in the direction perpendicular to the axis of the telescopic shaft 31.

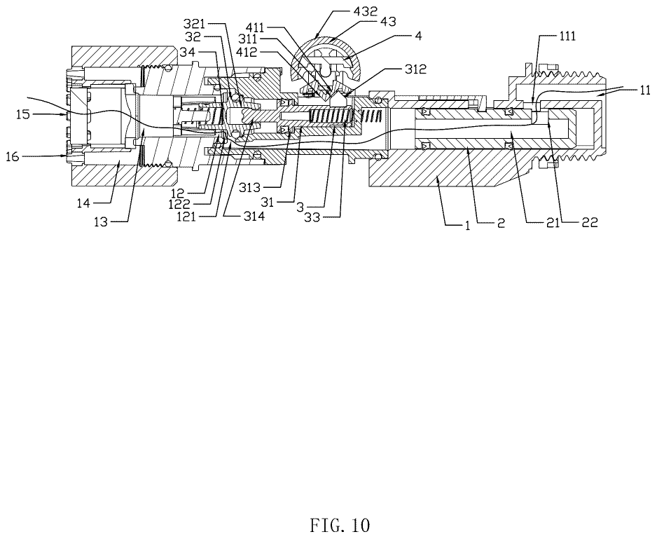

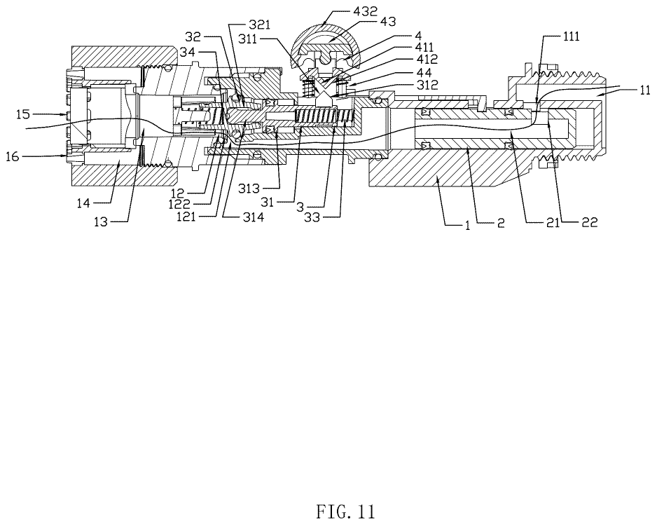

When the pressing base 41 is pressed through the combination key 43 again, referring to FIG. 10 and FIG. 11, the second pressing inclined surface 412 moves downward, squeezes the first driving inclined surface 311, and drives the telescopic shaft 31 to pull out the plug 32. The plug 32 opens the first water outlet 122 and blocks the second water outlet 123, and a state of blocking the second water outlet 123 is maintained through an elastic force of the second spring 34 and a water force. At this time, the second water outlet mode is switched to the first water outlet mode. After water stops in the water outlet main body 1, the switching member 3 restores to the initial state.

For a specific structure of the above travel limiting structure, in this embodiment, one end, facing the telescopic shaft 31, of the plug 32 is provided with a telescopic groove 321, and a groove opening of the telescopic groove 321 is a contraction opening. One end, facing the plug 32, of the telescopic shaft 31 is provided with a piston head 313, an end portion of the piston head 313 is provided with a telescopic rod 314 inserted into the telescopic groove 321, an end portion of the telescopic rod 314 is provided with a limiting head with a diameter greater than that of the contraction opening, and the travel limiting structure is formed between the telescopic groove 321 and the telescopic rod 314. The telescopic shaft 31 performs a reciprocating movement in the mounting cavity 12 through the piston head 313, and a V-shaped opening sealing ring with an opening facing the plug 32 is sleeved on an outer ring of the piston head 313.

In this embodiment, the water quantity adjusting member 2 and the switching member 3 are disposed side by side in an axial direction of the water outlet main body 1.

In this embodiment, to ensure that the pressing base 41 can be automatically ejected up, a compressed third spring 44 is disposed between the pressing base 41 and the water outlet main body 1, and the third spring 44 pushes the pressing base 41 to be away from the pressing end of the switching member 3, to implement that the pressing base 41 may automatically reset after being released. In addition, the water outlet main body 1 is provided with limiting plates 45 on two sides of the pressing base 41, and the two limiting plates 45 are provided with undercuts 451 limiting the pressing base 41 from separating from a mounting position. Tops of the two limiting plates 45 are provided with parallel and opposite strip-shaped openings 452, the strip-shaped openings 452 are parallel to a moving direction of the pressing base 41, and contraction openings are formed at the openings. A top of the pressing base 41 is provided with arc-shaped grooves 413 communicated with the two strip-shaped openings 452. During mounting, a rotating shaft of the combination key 43 is clamped into the two strip-shaped openings 452 and abuts against the arc-shaped grooves 413, the combination key 43 rotates on the arc-shaped grooves 413 and in the strip-shaped openings through the rotating shaft, or/and the combination key 43 performs a reciprocating movement in the two strip-shaped openings 452 through the rotating shaft and presses the pressing base 41.

For optional structures of the linkage member 42 and the water quantity adjusting member 2, in this embodiment, the linkage member 42 is telescopically mounted along an axis of the water outlet main body 1, and a circumference of the driving end is provided with a docked opening 421 parallel to a moving direction of the pressing base 41. A depth of the docked opening 421 is greater than a diameter of the driving head 431, and the driving head 431 of the combination key 43 is clamped into the docked opening 421. When the driving head 431 rotates around the rotating shaft of the combination key 43, the driving head 431 forms, in the docked opening 421, an action of pushing the docked opening 421 and an action of a reciprocating movement along the docked opening 421, thereby driving the linkage member 42 to perform a reciprocating movement along the axis of the water outlet main body 1. The water quantity adjusting member 2 is columnar, is telescopically mounted in the telescopic channel 17, and is driven by the linkage member 42. The water quantity adjusting member 2 blocks the telescopic channel 17, a middle portion of the water quantity adjusting member is provided with a water passing groove 21, a circumference of the water quantity adjusting member is provided with an adjusting hole 22 communicated with the water passing groove 21, and a groove opening of the water passing groove 21 is communicated with the water inlet 121 of the mounting cavity 12 through the telescopic channel 17. The water passing hole 111 is formed on a movement track of the adjusting hole 22, and the water quantity adjusting member 2 adjusts a water passing quantity of the water inlet channel 11 through a staggered degree between the adjusting hole 22 and the water passing hole 111. A structure is simple and is easy to form and assemble.

To facilitate implementing a rotating action of the combination key 43, the combination key 43 is provided with a pressing roller 432 coaxial with the rotating shaft of the combination key. In addition, to facilitate adjusting the water outlet quantity, when the pressing roller 432 rotates toward one direction and reaches a limiting position, the adjusting hole 22 is completely communicated with the water passing hole 111, and a water flow rate is maximum. Alternatively, when the pressing roller 432 rotates toward the other direction and reaches a limiting position, the adjusting hole 22 and the water passing hole 111 are completely staggered, and a water flow rate is minimum. Therefore, when the pressing roller 432 rolls toward one direction, the water outlet quantity may be reduced, and when the pressing roller rolls toward the other direction, the water outlet quantity may be increased, which may avoid a condition that an error occurs on flow rate adjustment.

In this embodiment, the water outlet head further includes a housing 5, one end of the housing 5 is a mounting opening, and the other end of the housing is a mounting contraction opening. The water outlet main body 1 is inserted from the mounting opening of the housing 5, and a water inlet end of the water outlet main body 1 is circumferentially provided with a thread, extends out of the mounting contraction opening of the housing 5, and is screwed and fastened through a nut 6. The housing 5 is provided with an avoidance hole 51 corresponding to the combination switch assembly 4, and the pressing roller 432 is docked with the combination key 43 through the avoidance hole 51 and is exposed from the avoidance hole 51, thereby further limiting the water outlet main body 1 in the housing 5. Preferably, the pressing roller 432 is assembled with the combination key 43 through a snap fit and a screw or in a bonded manner.

### Second Embodiment

A water outlet head of a second embodiment provided by the present invention mainly differs from that of the above first embodiment in that in the first embodiment, the water quantity adjusting member 2 and the switching member 3 are disposed side by side in the axial direction of the water outlet main body 1. In this way, the axial length of the water outlet head is long. However, in this embodiment, the water quantity adjusting member 2 and the switching member 3 are disposed side by side in a radial direction of the water outlet main body 1. In this way, the axial length of the water outlet head may be greatly shortened, so that the overall structure of the water outlet head is shorter and more compact.

Referring to FIG. 12 to FIG. 26, a water outlet head of a second embodiment provided by the present invention includes a water outlet main body 1, a water quantity adjusting member 2, a switching member 3, and a combination switch assembly 4.

The water outlet main body 1 is provided with a water inlet channel 11, a telescopic channel 17, a mounting cavity 12, a first water outlet channel 13, and a second water outlet channel 14. A circumference of the telescopic channel 17 is provided with a water passing hole 111 communicated with the water inlet channel 11, and the mounting cavity 12 is provided with a water inlet 121, a first water outlet 122, and a second water outlet 123 that are correspondingly communicated with the telescopic channel 17, the first water outlet channel 13, and the second water outlet channel 14 respectively. Preferably, water outlet ends of the first water outlet channel 13 and the second water outlet channel 14 form a bubble water outlet nozzle 15 and a shower water outlet nozzle 16 respectively.

The water quantity adjusting member 2 is telescopically mounted in the telescopic channel 17 and is matched with the water passing hole 111, and the switching member 3 is movably mounted in the mounting cavity 12. The water quantity adjusting member 2 and the switching member 3 are disposed side by side in the radial direction of the water outlet main body 1.

The combination switch assembly 4 is movably mounted on a circumference of the water outlet main body 1. The combination switch assembly 4 controls the water quantity adjusting member 2 through a rotating action to extend and retract and adjusts a size of the water passing hole 111. The combination switch assembly 4 controls the switching member 3 through a pressing action to form a switching action in the mounting cavity 12, and the water inlet 121 is communicated with the first water outlet 122 or the second water outlet 123 through the switching action of the switching member 3.

The water outlet head adopting the above solution has a water outlet mode switching function and a flow rate adjusting function at the same time, providing great convenience for a consumer during use of water. The combination switch assembly is disposed, so that two functional modules may be linked simultaneously, that is, one switch can control a water outlet mode and regulate a water outlet quantity. By reducing a disposing quantity of switches, a more compact water outlet head may be formed. In addition, in the water outlet head, the water quantity adjusting member and the switching member are disposed side by side in the radial direction of the water outlet main body. In this design, on the basis that the water outlet head has a function that one switch can control the water outlet mode and can regulate the water outlet quantity, the length of the water outlet head may be reduced to a great extent, so that the overall structure of the water outlet head is shorter and more compact and is more in line with a requirement for miniaturized design of the water outlet head of the consumer, and the structure is simple.

In this embodiment, the combination switch assembly 4 includes a pressing base 41, a linkage member 42, and a combination key 43. One end of the switching member 3 extends out of the mounting cavity 12 and forms a pressing end. The pressing base 41 is movably mounted on the circumference of the water outlet main body 1 and is matched with the pressing end of the switching member 3, and the pressing base 41 drives the pressing end of the switching member 3 through pressing to form the switching action, thereby implementing the water outlet mode switching function. The linkage member 42 is movably mounted on the circumference of the water outlet main body 1, one end of the linkage member is connected to the water quantity adjusting member 2, and the other end of the linkage member extends to be close to the pressing base 41 to form a driving end docked with the water quantity adjusting member 2. The combination key 43 is rotatably mounted at a top of the pressing base 41 and is provided with an eccentric driving head 431, and the driving head 431 is docked with and drives the driving end of the linkage member 42. Pressing the combination key 43 can drive the pressing base 41 to perform the pressing action. On the one hand, pressing the combination key 43 can drive the pressing base 41 to perform the pressing action, to form a switching function (that is, a water flow mode switching function). On the other hand, rotating the combination key 43 can drive the linkage member 42 through the driving head 431 to perform a telescopic action, to implement a flow adjusting function. When the water flow mode needs to be switched, the combination key 43 only needs to be pressed. When a flow rate of the water flow needs to be adjusted, the combination key 43 only needs to be rotated. An operation is very simple and convenient.

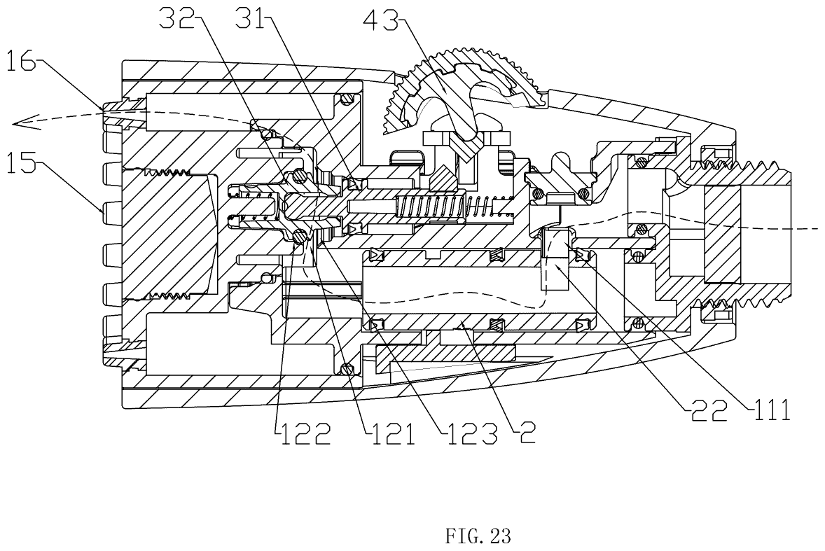

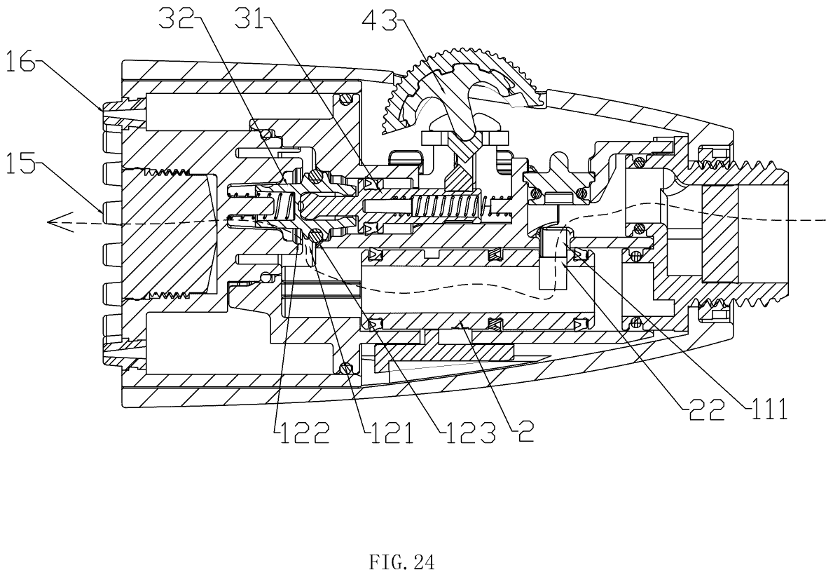

Specifically, the switching function of this embodiment is implemented through the following structures: The switching member 3 is telescopically mounted along an axis of the water outlet main body 1, and the switching member 3 includes a telescopic shaft 31 and a plug 32. The water inlet 121 is located between the first water outlet 122 and the second water outlet 123. When the plug 32 moves with the telescopic shaft 31 to block the second water outlet 123, the water inlet 121 is communicated with the first water outlet 122. At this time, the bubble water outlet nozzle 15 discharges water (as shown in FIG. 24). Alternatively, when the plug 32 moves with the telescopic shaft 31 to block the first water outlet 122, the water inlet 121 is communicated with the second water outlet 123. At this time, the shower water outlet nozzle 16 discharges water (as shown in FIG. 23). The pressing base 41 squeezes the telescopic shaft 31 through an inclined surface to form the switching action, so that a pressing direction may be changed, and a pressing force of the circumference can drive the axially disposed switching member 3 to move axially. The pressing base 41 squeezes the telescopic shaft 31 through the inclined surface to form the switching action, which adopts a structure the same as that of the above first embodiment. To be specific, a circumference of the pressing end of the telescopic shaft 31 is provided with a first driving inclined surface 311 and a second driving inclined surface 312, and the pressing base 41 is provided with a first pressing inclined surface 411 and a second pressing inclined surface 412 that face the circumference of the pressing end. The first pressing inclined surface 411 is parallel to the second driving inclined surface 312, and the second pressing inclined surface 412 is parallel to the first driving inclined surface 311. The plug 32 is telescopically mounted on the telescopic shaft 31, and a travel limiting structure is disposed in a telescopic direction, to prevent the plug 32 and the telescopic shaft 31 from separating from each other. A pre-tensioned first spring 33 is disposed between the pressing end of the telescopic shaft 31 and the water outlet main body 1, and a pre-tensioned second spring 34 is disposed between an end portion of the plug 32 and the water outlet main body 1. By adopting the above inclined surface squeezing switching structure, the switching action of the switching member 3 may be implemented. A structure and a working principle thereof are the same as those of the first embodiment, which are not described in detail herein.

In this embodiment, one side of the water outlet main body 1 is provided with a first through hole 19a communicated with the mounting cavity 12, and the other side of the water outlet main body is provided with a second through hole 19b communicated with the telescopic channel 17. The first through hole 19a allows the pressing end of the switching member 3 to extend out of the mounting cavity 12, and the second through hole 19b allows the linkage member 42 to be connected to the water quantity adjusting member 2.

In this embodiment, the linkage member 42 includes a bottom wall and side walls connected to two ends of the bottom wall of the linkage member 42 respectively. The bottom wall and the two side walls of the linkage member 42 form a U-shaped structure, and the U-shaped structure is sleeved on a periphery of the water outlet main body 1. An inner surface of the bottom wall of the linkage member 42 is provided with a clamping rib 422, and an outer surface of the water quantity adjusting member 2 is provided with a clamping groove 23 matched with the clamping rib 422. The clamping rib 422 is clamped to and matched with the clamping groove 23, so that the linkage member 42 can drive the water quantity adjusting member 2 to extend and retract axially. In another embodiment, the clamping rib 422 may also be disposed on an inner surface of the side wall of the linkage member 42, which has the same effect. In this embodiment, the water quantity adjusting member 2 is hollow and columnar and extends and retracts along the axis of the water outlet main body 1. The clamping groove 23 extends in a circumferential direction of the water quantity adjusting member 2. The linkage member 42 adopting the U-shaped structure is sleeved on an outer circumference of the water outlet main body 1 to be linked to the water quantity adjusting member 2 located in the water outlet main body 1. A structure is simple and compact, and transmission is reliable.

In this embodiment, the linkage member 42 is telescopically mounted along the axis of the water outlet main body 1. The side wall of the linkage member 42 is provided with a docked opening 421 parallel to a moving direction of the pressing base 41. The driving head 431 of the combination key 43 is clamped into the docked opening 421 and drives the linkage member 42 to perform a reciprocating movement along the axis of the water outlet main body 1. The side wall of the linkage member 42 is provided with the docked opening 421, so that the combination key 43 is linked to the linkage member 42 by clamping the driving head 431 into the docked opening 421. Therefore, a transmission structure is simple and reliable, and the design is very ingenious.

To facilitate mounting the linkage member 42 on the outer circumference of the water outlet main body 1 in an axial moving manner, in this embodiment, a top end of the side wall of the linkage member 42 is provided with a barb 423, and the water outlet main body 1 is provided with a stepped surface 110 matched with the barb 423, so that the linkage member 42 is mounted on the water outlet main body 1 by clamping the barb 423 on the stepped surface 110. An outer surface of the water outlet main body 1 is axially provided with a protruding rib 18, and the inner surface of the side wall of the linkage member 42 is provided with a groove 424 matched with the protruding rib. In another embodiment, alternatively, an outer surface of the water outlet main body 1 is axially provided with a groove, and the inner surface of the side wall of the linkage member 42 is provided with a protruding rib matched with the groove. Alternatively, the protruding rib or the groove formed on the inner surface of the side wall of the linkage member 42 may also be formed on the bottom wall of the linkage member 42. The protruding rib is matched with the groove, so that sliding of the linkage member 42 along the axis of the water outlet main body 1 is guided. The linkage member 42 is clamped to the water outlet main body 1 in an axial moving manner by disposing the barb 423. A structure is simple and assembly is convenient.

In this embodiment, the water outlet main body 1 includes, in a water flow direction, a water inlet section 1a, a middle section 1b, and a water outlet section 1c that are connected sequentially. The water inlet channel 11 includes a first water inlet channel 11a and a second water inlet channel 11b that are communicated sequentially. The first water inlet channel 11a is located in the water inlet section 1a. The second water inlet channel 11b, the telescopic channel 17, and the mounting cavity 12 are integrally formed in the middle section 1b, and the telescopic channel 17 is located on one side of the mounting cavity 12 and the second water inlet channel 11b. The design of dividing the water outlet main body 1 into three sections is conducive to forming various channels in the water outlet main body 1. The telescopic channel 17 is located on one side of the mounting cavity 12 and the second water inlet channel 11b, which means that the telescopic channel 17 is juxtaposed to the mounting cavity 12 and the second water inlet channel 11b in a radial direction of the water outlet main body 1. This design can greatly reduce the axial length of the water outlet main body 1, achieving the purpose of shortening the overall size of the water outlet head.

In the embodiment, the telescopic channel 17 and the second water inlet channel 11b respectively and axially extend to an end portion of one end, connected to the water inlet section 1a, of the middle section 1b, forming a first end opening 171 of the telescopic channel 17 and an inlet 11b1 of the second water inlet channel 11b respectively. One end, facing the middle section 1b, of the water inlet section 1a is provided with an outlet of the first water inlet channel 11a and a blocking portion 1a1 respectively. The outlet of the first water inlet channel 11a is in sealing connection with the inlet 11b1 of the second water inlet channel 11b when the water inlet section 1a is connected to the middle section 1b, and the blocking portion 1a1 blocks the first end opening 171 of the telescopic channel 17. A position, corresponding to the water passing hole 111, on a side wall of the second water inlet channel 11b is provided with a process hole 112 forming the water passing hole 111, and the process hole 112 is sealed through a sealing stopper 7. The telescopic channel 17 and the second water inlet channel 11b respectively and axially extend to the end portion of one end, connected to the water inlet section 1a, of the middle section 1b, and the process hole 112 is designed to form the water passing hole 111, so that the middle section 1b is formed more simply and easily.

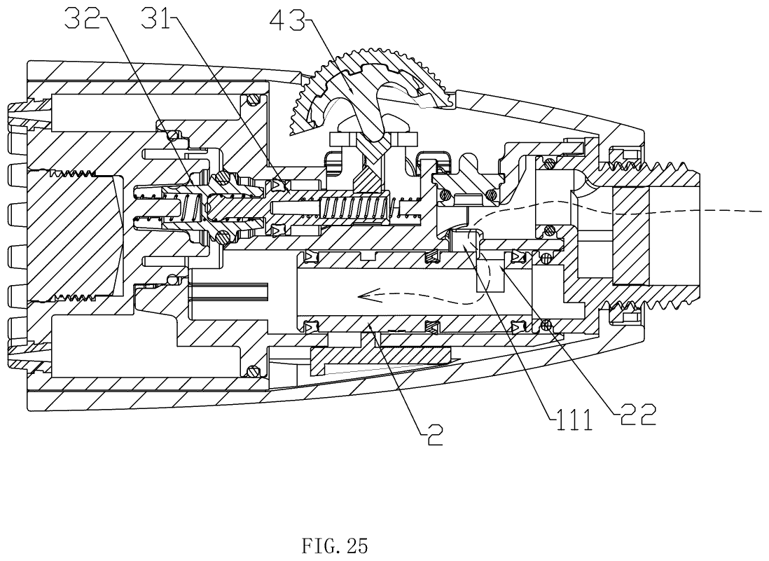

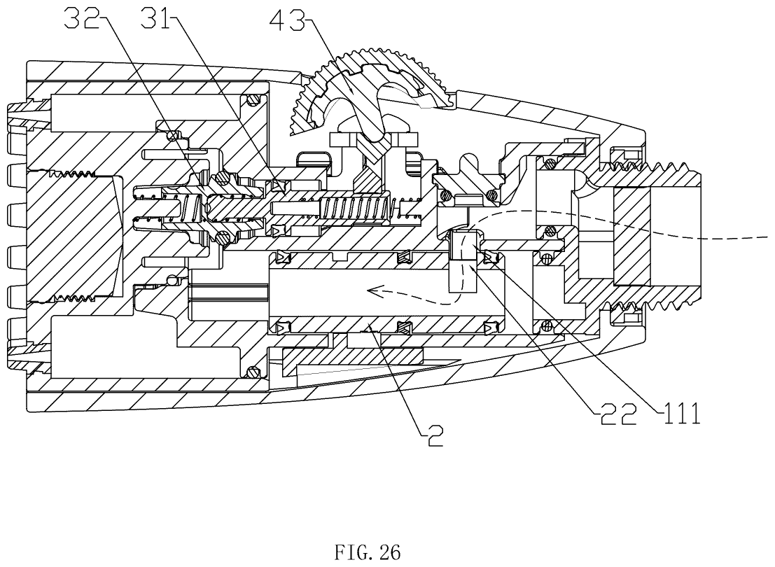

In this embodiment, the water quantity adjusting member 2 is columnar, is telescopically mounted in the telescopic channel 17, and is driven by the linkage member 42. A middle portion of the water quantity adjusting member 2 is provided with a water passing groove 21, a circumference of the water quantity adjusting member is provided with an adjusting hole 22 communicated with the water passing groove 21, and a groove opening of the water passing groove 21 is communicated with the water inlet 121 of the mounting cavity 12 through the telescopic channel 17. The water passing hole 111 is formed on a movement track of the adjusting hole 22, and the water quantity adjusting member 2 adjusts a water passing quantity of the water inlet channel 11 through a staggered degree between the adjusting hole 22 and the water passing hole 111. A structure is simple and is easy to form and assemble. Referring to FIG. 25, at this time, the staggered degree between the adjusting hole 22 and the water passing hole 111 is large, and an overlapping part between the adjusting hole 22 and the water passing hole 111 is small. Therefore, the water passing quantity is small. Referring to FIG. 26, at this time, the staggered degree between the adjusting hole 22 and the water passing hole 111 is minimum, and the adjusting hole 22 completely overlaps the water passing hole 111. Therefore, the water passing quantity is maximum.

To facilitate implementing a rotating action of the combination key 43, the combination key 43 is provided with a pressing roller 432 coaxial with the rotating shaft of the combination key. In addition, to facilitate adjusting the water outlet quantity, when the pressing roller 432 rotates toward one direction and reaches a limiting position, the adjusting hole 22 is completely communicated with the water passing hole 111, and a water flow rate is maximum. Alternatively, when the pressing roller 432 rotates toward the other direction and reaches a limiting position, the adjusting hole 22 and the water passing hole 111 are completely staggered, and a water flow rate is minimum. Therefore, when the pressing roller 432 rolls toward one direction, the water outlet quantity may be reduced, and when the pressing roller rolls toward the other direction, the water outlet quantity may be increased, which may avoid a condition that an error occurs on flow rate adjustment.

In this embodiment, the water outlet head further includes a housing 5, one end of the housing 5 is a mounting opening, and the other end of the housing is a mounting contraction opening. The water outlet main body 1 is inserted from the mounting opening of the housing 5, and the water inlet section 1a of the water outlet main body 1 is circumferentially provided with a thread, extends out of the mounting contraction opening of the housing 5, and is screwed and fastened through a nut 6. The housing 5 is provided with an avoidance hole 51 corresponding to the combination switch assembly 4, and the pressing roller 432 is docked with the combination key 43 through the avoidance hole 51 and is exposed from the avoidance hole 51, thereby further limiting the water outlet main body 1 in the housing 5. Preferably, the pressing roller 432 is assembled with the combination key 43 through a snap fit and a screw or in a bonded manner.

In this embodiment, the remaining structures and working principles that are not described are the same as those of the above first embodiment, which are not described herein in detail again.

The water outlet head of the present invention has a water outlet mode switching function and a flow rate adjusting function at the same time, providing great convenience for a consumer during use of water. In addition, the combination switch assembly is disposed, so that two functional modules may be linked simultaneously, that is, one switch can control the water outlet mode and regulate a water outlet quantity. In an aspect, by reducing a disposing quantity of switches, a more compact water outlet head may be formed, which avoids a problem of a large product size or a small water flow channel caused when a plurality of switches are disposed, may not cause a problem that the water outlet head is large in size and is out of proportion with a faucet, and may also not cause a problem of a small water flow rate. In addition, the switching member adopted by the present invention has an automatic reset function after water is shut off, so that the switching member can automatically restore to an initial water outlet mode after each use of water, avoiding trouble for the next use.

The water outlet head of the present invention is generally used in conjunction with a faucet or may be used as a handheld shower separately.

Although the above embodiments have been shown and described, it can be understood that the above embodiments are exemplary and shall not be construed as a limitation on the present invention. Changes, modifications, substitutions, and variants made by those of ordinary skill in the art on the above embodiments shall fall within the protection scope of the present invention.

What is claimed is:

1. A water outlet head, comprising a water outlet main body, a water quantity adjusting member, a switching member, and a combination switch assembly, wherein
the water outlet main body is provided with a water inlet channel, a telescopic channel, a mounting cavity, a first water outlet channel, and a second water outlet channel; and a circumference of the telescopic channel is provided with a water passing hole communicated with the water inlet channel, and the mounting cavity is provided with a water inlet, a first water outlet, and a second water outlet that are correspondingly communicated with the telescopic channel, the first water outlet channel, and the second water outlet channel respectively;
the water quantity adjusting member is telescopically mounted in the telescopic channel and is matched with the water passing hole, and the switching member is movably mounted in the mounting cavity; and
the combination switch assembly is movably mounted on a circumference of the water outlet main body, controls the water quantity adjusting member through a rotating action to extend and retract, adjusts a size of the water passing hole, and controls the switching member through a pressing action to form a switching action in the mounting cavity, the water inlet is communicated with the first water outlet or the second water outlet through the switching action of the switching member, and the switching member automatically restores to an initial state in a water shut-off state of the water outlet main body and controls the water inlet, the first water outlet, and the second water outlet to restore to an initial communicated state.

2. The water outlet head according to claim 1, wherein the combination switch assembly comprises a pressing base, a linkage member, and a combination key; one end of the switching member extends out of the mounting cavity and forms a pressing end; the pressing base is movably mounted on the circumference of the water outlet main body and is matched with the pressing end of the switching member, and the pressing base drives the pressing end of the switching member through pressing to form the switching action; the linkage member is movably mounted on the circumference of the water outlet main body, one end of the linkage member is connected to the water quantity adjusting member, and the other end of the linkage member extends to be close to the pressing base to form a driving end; and the combination key is rotatably mounted at a top of the pressing base and is provided with an eccentric driving head, and the driving head is docked with and drives the driving end of the linkage member.

3. The water outlet head according to claim 2, wherein the switching member is telescopically mounted along an axis of the water outlet main body and comprises a telescopic shaft and a plug; the water inlet is located between the first water outlet and the second water outlet; and when the plug moves with the telescopic shaft to block the second water outlet, the water inlet is communicated with the first water outlet, or when the plug moves with the telescopic shaft to block the first water outlet, the water inlet is communicated with the second water outlet.

4. The water outlet head according to claim 3, wherein the pressing base squeezes the telescopic shaft through an inclined surface to form the switching action.

5. The water outlet head according to claim 4, wherein a circumference of the pressing end of the telescopic shaft is provided with a first driving inclined surface and a second driving inclined surface, the pressing base is provided with a first pressing inclined surface and a second pressing inclined surface that face the circumference of the pressing end, the first pressing inclined surface is parallel to the second driving inclined surface, and the second pressing inclined surface is parallel to the first driving inclined surface; the plug is telescopically mounted on the telescopic shaft, and a travel limiting structure is disposed in a telescopic direction; and a pre-tensioned first spring is disposed between the pressing end of the telescopic shaft and the water outlet main body, and a pre-tensioned second spring is disposed between an end portion of the plug and the water outlet main body;
in the initial state, the second spring pushes and presses the plug onto the second water outlet, the water inlet is communicated with the first water outlet, the first spring pushes the telescopic shaft, a length between the telescopic shaft and the plug is retracted to be in a shortest length state, and the first pressing inclined surface and the second driving inclined surface are staggered in a direction perpendicular to an axis of the telescopic shaft; and
in a water passing state, the pressing base is pressed through the combination key, the first pressing inclined surface moves downward, squeezes the second driving inclined surface, and drives the telescopic shaft to push the plug, the plug compresses the second spring and blocks the first water outlet, and the water inlet is communicated with the second water outlet; the pressing base is reset by releasing the combination key, water pressure in the mounting cavity is greater than elasticity of the second spring, a state that the plug blocks the first water outlet is maintained, the water pressure in the mounting cavity pushes the telescopic shaft to reset and compress the first spring, the length between the telescopic shaft and the plug is extended to be in a longest length state, and the second pressing inclined surface and the first driving inclined surface are staggered in the direction perpendicular to the axis of the telescopic shaft; the pressing base is pressed through the combination key again, the second pressing inclined surface moves downward, squeezes the first driving inclined surface, and drives the telescopic shaft to pull out the plug, the plug opens the first water outlet and blocks the second water outlet, and a state of blocking the second water outlet is maintained through an elastic force of the second spring and a water force; and after water stops in the water outlet main body, the switching member restores to the initial state.

6. The water outlet head according to claim 5, wherein one end, facing the telescopic shaft, of the plug is provided with a telescopic groove, a groove opening of the telescopic groove is a contraction opening, one end, facing the plug, of the telescopic shaft is provided with a piston head, an end portion of the piston head is provided with a telescopic rod inserted into the telescopic groove, an end portion of the telescopic rod is provided with a limiting head with a diameter greater than that of the contraction opening, and the travel limiting structure is formed between the telescopic groove and the telescopic rod; and the telescopic shaft performs a reciprocating movement in the mounting cavity through the piston head, and a V-shaped opening sealing ring with an opening facing the plug is sleeved on an outer ring of the piston head.

7. The water outlet head according to claim 2, wherein a compressed third spring is disposed between the pressing base and the water outlet main body, and the third spring pushes the pressing base to be away from the pressing end of the switching member; the water outlet main body is provided with limiting plates on two sides of the pressing base, and the two limiting plates are provided with undercuts limiting the pressing base from separating from a mounting position; tops of the two limiting plates are provided with parallel and opposite strip-shaped openings, the strip-shaped openings are parallel to a moving direction of the pressing base, and contraction openings are formed at the openings; a top of the pressing base is provided with arc-shaped grooves communicated with the two strip-shaped openings; and a rotating shaft of the combination key is clamped into the two strip-shaped openings and abuts against the arc-shaped grooves, the combination key rotates on the arc-shaped grooves through the rotating shaft, or/and the combination key performs a reciprocating movement in the two strip-shaped openings through the rotating shaft and presses the pressing base.

8. The water outlet head according to claim 2, wherein the linkage member is telescopically mounted along an axis of the water outlet main body, a circumference of the driving end is provided with a docked opening parallel to a moving direction of the pressing base, a depth of the docked opening is greater than a diameter of the driving head, and the driving head of the combination key is clamped into the docked opening and drives the linkage member to perform a reciprocating movement along the axis of the water outlet main body; the water quantity adjusting member is columnar, is telescopically mounted in the telescopic channel, and is driven by the linkage member; the water quantity adjusting member blocks the telescopic channel, a middle portion of the water quantity adjusting member is provided with a water passing groove, a circumference of the water quantity adjusting member is provided with an adjusting hole communicated with the water passing groove, and a groove opening of the water passing groove is communicated with the water inlet of the mounting cavity through the telescopic channel; and the water passing hole is formed on a movement track of the adjusting hole, and the water quantity adjusting member adjusts a water passing quantity of the water inlet channel through a staggered degree between the adjusting hole and the water passing hole.

9. The water outlet head according to claim 8, wherein the combination key is provided with a pressing roller coaxial with a rotating shaft of the combination key; when the pressing roller rotates toward one direction and reaches a limiting position, the adjusting hole is completely communicated with the water passing hole, and a water flow rate is maximum; or when the pressing roller rotates toward the other direction and reaches a limiting position, the adjusting hole and the water passing hole are completely staggered, and a water flow rate is minimum.

10. The water outlet head according to claim 9, wherein the water outlet head further comprises a housing, one end of the housing is a mounting opening, and the other end of the housing is a mounting contraction opening; the water outlet main body is inserted from the mounting opening of the housing, and a water inlet end of the water outlet main body is circumferentially provided with a thread, extends out of the mounting contraction opening of the housing, and is screwed and fastened through a nut; and the housing is provided with an avoidance hole corresponding to the combination switch assembly, and the pressing roller is docked with the combination key through the avoidance hole and is exposed from the avoidance hole.

11. The water outlet head according to claim 2, wherein the water quantity adjusting member and the switching member are disposed side by side in a radial direction of the water outlet main body.

12. The water outlet head according to claim 11, wherein one side of the water outlet main body is provided with a first through hole communicated with the mounting cavity, the other side of the water outlet main body is provided with a second through hole communicated with the telescopic channel, the first through hole allows the pressing end of the switching member to extend out of the mounting cavity, and the second through hole allows the linkage member to be connected to the water quantity adjusting member.

13. The water outlet head according to claim 12, wherein the linkage member comprises a bottom wall and side walls connected to two ends of the bottom wall of the linkage member respectively, the bottom wall and the two side walls of the linkage member form a U-shaped structure, the U-shaped structure is sleeved on a periphery of the water outlet main body, an inner surface of the bottom wall or the side wall of the linkage member is provided with a clamping rib, and an outer surface of the water quantity adjusting member is provided with a clamping groove matched with the clamping rib.

14. The water outlet head according to claim 13, wherein the linkage member is telescopically mounted along an axis of the water outlet main body, the side wall of the linkage member is provided with a docked opening parallel to a moving direction of the pressing base, and the driving head of the combination key is clamped into the docked opening and drives the linkage member to perform a reciprocating movement along the axis of the water outlet main body.

15. The water outlet head according to claim 13, wherein a top end of the side wall of the linkage member is provided with a barb, the water outlet main body is provided with a stepped surface matched with the barb, an outer surface of the water outlet main body is axially provided with a groove or a protruding rib, and the inner surface of the side wall or the bottom wall of the linkage member is provided with a protruding rib or a groove matched with the groove or the protruding rib.

16. The water outlet head according to claim 11, wherein the water outlet main body comprises, in a water flow direction, a water inlet section, a middle section, and a water outlet section that are connected sequentially, the water inlet channel comprises a first water inlet channel and a second water inlet channel that are communicated sequentially, the first water inlet channel is located in the water inlet section, the second water inlet channel, the telescopic channel, and the mounting cavity are integrally formed in the middle section, and the telescopic channel is located on one side of the mounting cavity and the second water inlet channel.

17. The water outlet head according to claim 16, wherein the telescopic channel and the second water inlet channel respectively and axially extend to an end portion of one end, connected to the water inlet section, of the middle section, forming a first end opening of the telescopic channel and an inlet of the second water inlet channel respectively, one end, facing the middle section, of the water inlet section is provided with an outlet of the first water inlet channel and a blocking portion respectively, the outlet of the first water inlet channel is in sealing connection with the inlet of the second water inlet channel when the water inlet section is connected to the middle section, and the blocking portion blocks the first end opening of the telescopic channel; and a position, corresponding to the water passing hole, on a side wall of the second water inlet channel is provided with a process hole forming the water passing hole, and the process hole is sealed through a sealing stopper.

18. The water outlet head according to claim 16, wherein the water outlet head further comprises a housing, one end of the housing is a mounting opening, and the other end of the housing is a mounting contraction opening; the water outlet main body is inserted from the mounting opening of the housing, and the water inlet section of the water outlet main body is circumferentially provided with a thread, extends out of the mounting contraction opening of the housing, and is screwed and fastened through a nut; and the housing is provided with an avoidance hole corresponding to the combination switch assembly.
